(19) United States
(12) Patent Application Publication
(10) Pub. No.: US 2009/0214064 A1
(43) Pub. Date: Aug. 27, 2009

(54) RF power supply for hearing aids

(75) Inventors: Fan Wu, Scottsdale, AZ (US); Samuel L. Thomasson, Gilbert, AZ (US)

Correspondence Address: Paul F. Wille, 6407 East Clinton St., Scottsdale, AZ, 85254, US

(73) Assignee: Zounds, Inc., Mesa, AZ (US)

(21) Appl. No.: 12/072,148

(22) Filed: Feb. 25, 2008

(51) Int. Cl. H04R 25/00

(52) U.S. Cl. 381/315; 381/323

(57) ABSTRACT

A hearing aid includes an antenna and is powered by one or more signals received by the antenna. At least some of the power for operating the hearing aid is derived from a received signal. Power not used for operation is used for charging a battery, if any, in the hearing aid. The signal can be modulated for one-way communication or there is two-way communication if the hearing aid includes a transmitter coupled to the same antenna or a second antenna.

This invention relates to hearing aids and, in particular, to a hearing aid powered, at least in part, by radio frequency (RF) energy.

### BACKGROUND TO THE INVENTION

Deriving power from RF signals is more than one hundred years old. The crystal based receivers in the early days of radio were the first in a long line of devices powered by RF energy; e.g. see U.S. Pat. No. 918,618 (Way) and U.S. Pat. No. 1,748,435 (Adams et al.). Although still in use today among hobbyists, the crystal radio was replaced long ago by battery powered and line powered radios. The desire to use RF energy as a power source remained.

The invention of the transistor dramatically reduced the power needed by electronic devices and renewed interest in RF signals as a source of power. For example, U.S. Pat. No. 2,607,004 (Harris) discloses an RF powered walkie-talkie using diodes. U.S. Pat. No. 2,682,638 (Enabnit) discloses a signal powered bridge amplifier using active devices. U.S. Pat. No. 2,777,057 (Pankove) discloses several RF powered circuits with active devices. U.S. Pat. No. 2,851,592 (Webster, Jr.) discloses a carrier wave powered transceiver. U.S. Pat. No. 2,918,573 (Hollmann) discloses a “self-powered” detector-amplifier circuit. U.S. Pat. No. 2,997,535 (Brady et al.) discloses a remote control that receives RF power from a transmitter in a television and transmits a modulated or encoded signal for controlling the television. U.S. Pat. No. 3,118,145 (Nee) discloses a carrier powered paging system. U.S. Pat. No. 4,314,306 (Darrow) discloses a signal powered receiver for operating a relay. In all these patents, a transmitted signal is converted to electrical energy that is stored in a capacitor. Some of the circuits disclosed are broadband and some, like the crystal sets of old, are tuned to a narrow band of frequencies.

More recently, it has been proposed, if not actually accomplished, to transmit large amounts of power, e.g. from solar panels in synchronous orbit around the earth. A less grand proposal suggests transmitting power from a nearby transmitter; e.g. U.S. Patent Application Publication 2005/0104453 (Vanderelli et al.).

A hearing aid requires very little power, on the order of milliwatts. A problem is that a hearing aid requires a continuous supply of power. Batteries supply the power and new technology has increased battery life greatly, yet it is annoying to have to replace batteries. Hearing changes with time. It is unlikely that a single battery can last the same period of time, now or in the foreseeable future. Rechargeable batteries are a partial solution but require removal of the hearing aid and placement in a charger. Unless the user has two sets of hearing aids, the charging can be inconvenient.

Another problem caused by the need to replace batteries is the need to open the hearing aid. Moisture, wax, dirt, oils and so on, can work their way into a hearing aid, causing problems. Hearing aids can be made relatively impervious to ambient conditions. A hearing aid that is relatively impervious is also likely to be relatively difficult to open.

Another problem is that a hearing aid is physically small. Other factors being equal, signal strength is proportional to the size of the antenna and there is not a lot of room inside a hearing aid. U.S. Pat. No. 7,260,234 (Kasztelan et al.) proposes, for a battery powered hearing aid, winding an antenna around the outside of a hearing aid. The antenna is for communication.

In view of the foregoing, it is therefore an object of the invention to provide a hearing aid powered, at least in part, by radio frequency waves.

Another object of the invention is to provide a hearing aid that is rechargeable from radio frequency waves.

A further object of the invention is to provide a hearing aid that can be sealed.

### SUMMARY OF THE INVENTION

The foregoing objects are achieved by this invention in which a hearing aid includes an antenna and is powered by one or more signals received by the antenna. At least some of the power for operating the hearing aid is derived from a received signal. Power not used for operation is used for charging a battery, if any, in the hearing aid. The signal can be modulated for one-way communication or there is two-way communication if the hearing aid includes a transmitter coupled to the same antenna or a second antenna.

### BRIEF DESCRIPTION OF THE DRAWINGS

A more complete understanding of the invention can be obtained by considering the following detailed description in conjunction with the accompanying drawings, in which:

FIG. 1 illustrates a behind-the-ear (BTE) hearing aid adapted for RF power in accordance with a preferred embodiment of the invention;

FIG. 2 illustrates an alternative embodiment of the invention;

FIG. 3 illustrates an RF transmitter for supplying power to one or more hearing aids in accordance with a preferred embodiment of the invention;

FIG. 4 illustrates an in-the-canal (ITC) hearing aid adapted for RF power in accordance with a preferred embodiment of the invention; and

FIG. 5 illustrates a detector circuit.

### DETAILED DESCRIPTION OF THE INVENTION

The term “RF” is not intended to imply any particular frequency or band of frequencies but is intended to imply induced voltage or current; i.e. photovoltaic conversion such as disclosed in U.S. Pat. No. 5,210,804 (Schmid) is excluded. Also, there are government regulations covering the allocation of frequencies for various uses and the amount of power that can be emitted. Unless the context indicates otherwise, the mention of a particular frequency is not intended as a limitation on the invention but as a recognition of the regulations, which may vary from country to country.

A “speaker” converts electrical current into sound. In the hearing aid art, one often encounters the term “receiver” for such a device, which reads strangely to the uninitiated and is confusing in the context of this invention. “Electroacoustic transducer” is clumsy and pedantic. Thus, “speaker” is the term used for describing this invention. A “receiver” is a device that is coupled to an antenna for receiving electrical signals from the antenna.

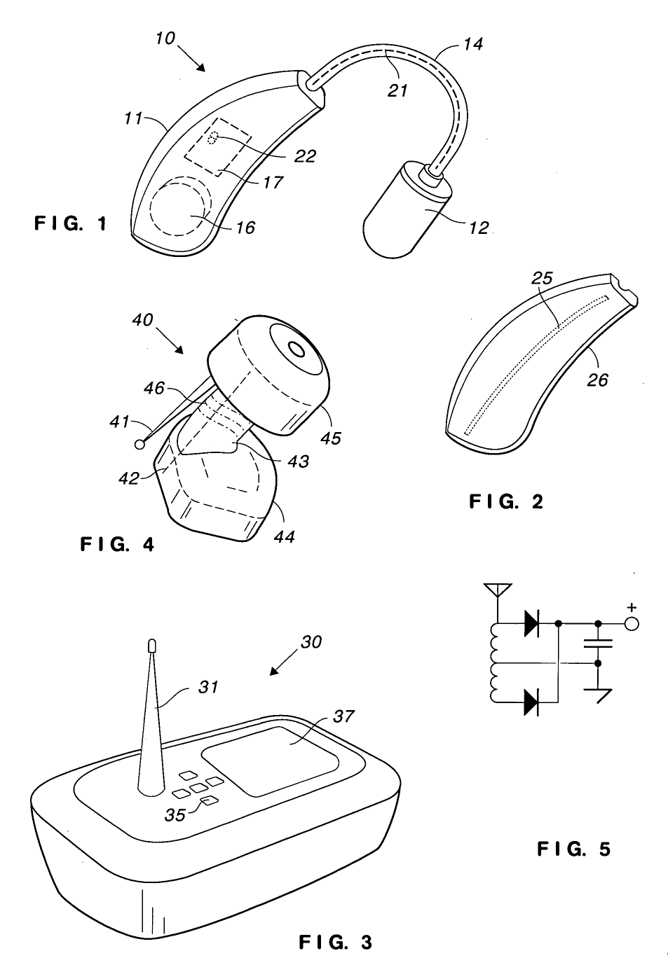

In FIG. 1, hearing aid 10 includes body 11 coupled to earpiece 12 by cable 14. Within body 11 are battery 16 and circuit board 17. Circuit board 17 includes the audio processing electronics for providing hearing correction. A speaker (not shown) is located in earpiece 12 and a microphone (not shown) is located in body 11. The speaker, microphone, circuit board, and battery are electrically connected. As described thus far, hearing aid 10 is conventional.

In accordance with one aspect of the invention, hearing aid 10 includes antenna 21 located in cable 14 and coupled to a receiver on circuit board 17, which detects an RF signal on antenna 21 and stores energy from the RF signal on capacitor 22. FIG. 2 illustrates an alternative embodiment of the invention in which antenna 25 is molded into outer shell 26 of a BTE hearing aid. A conductive tab (not shown in FIG. 2) emerges from the inside of shell 26 for electrical contact.

For good reception, an antenna should be at least one quarter wavelength long. At 3 GHz, the wavelength is 10 cm or approximately 2 inches. Thus, the embodiments of either FIG. 1 or FIG. 2 provide ample antenna length. Low power, e.g. on the order of 100 mW, emissions can be made highly directional, if desired, and have a short range, e.g. less than 100 feet, except under clear, line-of-sight conditions where the range can be much greater. In ordinary, urban environments, 100 mW would provide adequate coverage for a house, for example.

As with any radio signal, amplitude decreases with the square of the distance from the source. “Range” means the distance over which sufficient signal exists for powering a hearing aid, which is less than the distance over which a signal can be detected.

FIG. 3 illustrates a transmitter for remotely powering a hearing aid. The transmitter is line powered or battery powered, or both. The location of antenna 31 on transmitter 30 depends upon the usage of the transmitter. If intended for portable use, the antenna extends from any convenient side or is parallel to a side for protection. Alternatively, an antenna is molded into the case of transmitter 30.

Plural antennas can be used to assure that at least one antenna is in an optimal position as transmitter 30 is carried. Position sensing circuitry, such as used in cameras for detecting “portrait” or “landscape” orientation, can be used n transmitter 30 for selecting the optimum antenna. Alternatively, or in addition, transmitter 30 can question the hearing aid (modulate the transmitted signal) and change antennas until it receives a response from the hearing aid, thereby indicating a preferred orientation.

As a portable unit, transmitter 30 is used as a remote control in accordance with another aspect of the invention. Transmitter 30 includes a few dedicated buttons or includes selection buttons, such as button 35, and display screen 37 for displaying suitable graphics or a menu. Thus configured, transmitter 30 provides a modulated signal that supplies power, data, and control for a hearing aid constructed in accordance with the invention. By way of example only, data includes an identification code and control includes volume up, volume down, and filter selection for various ambient conditions, e.g. library, restaurant, or theater. As a portable unit, transmitter 30 includes rechargeable batteries and preferably includes a power line input for table top operation.

FIG. 4 illustrates an in-the-ear hearing aid 40 in which pull tab 41 includes an antenna. Pull tab 41 is at least one centimeter long and provides sufficient reception at 1.5 GHz and above. Alternatively, as indicated by dashed line 42, an antenna is optionally located within hearing aid 40, extending from body 44 to ear plug 45 along neck 43. Another option, indicated by dot-dash lines 46, an antenna is coiled within neck 43.

Irrespective of the kind of hearing aid and the location of the antenna, the received signal is rectified and the energy is stored on a capacitor as voltage, as illustrated in FIG. 5. The voltage is then used for power by the electronics within the hearing aid. As apparent from the Background of the Invention, rectifying circuits (“detectors” in radio terminology) are well known in the art and exist in all radios, not just RF powered radios. The circuit illustrated in FIG. 5 includes a full wave rectifier. A half wave rectifier could be used instead but is not as efficient. There are many designs for detectors and the design is not critical for the invention.

Integrated circuits can be made to consume very little power and operate on a supply voltage as low 1.2 volts. The antenna is coupled to a tuned circuit in the receiver. The tuned circuit reduces noise and improves efficiency at the carrier frequency; e.g. 1 GHz and above. As described above, the carrier signal can be modulated for one way or for two way communication between transmitter 30 and the hearing aid.

In accordance with one aspect of the invention, the RF energy supplements battery power. In accordance with another aspect of the invention, RF energy charges the battery when not being consumed during use. In accordance with yet another aspect of the invention, capacitor 22 (FIG. 1) is the sole source of power for a hearing aid.

The invention thus provides a hearing aid powered, at least in part, by radio frequency waves. The invention also provides a hearing aid that is rechargeable from radio frequency waves. Batteries can typically be charged many times. Thus, the invention also provides a hearing aid that can be sealed for greater reliability.

Having thus described the invention, it will be apparent to those of skill in the art that various modifications can be made within the scope of the invention. For example, the antenna can be wire or metal foil. In FIG. 2, the antenna can be metal foil on the inside of shell 26, rather than molded into the shell. This allows one to make either a dipole antenna or a “long wire” (relatively speaking) antenna from the same part. The only difference is whether one connects at the end or the middle (after making a break in the middle). Although described in connection with two types of hearing aids, the invention is applicable to other types of hearing aids. Transmitter 30 can be carried, wall mounted, placed on a horizontal surface or, in general, placed at any convenient location for sending power to one or more hearing aids. It is preferred that the frequency of transmission be above 1 GHz to have a wavelength on the order of the largest dimension of the hearing aid but this is a preference and not a requirement.

What is claimed as the invention is:

1. A hearing aid including electronics for processing audio signals, a speaker coupled to said electronics, and a microphone coupled to said electronics characterized in that:
an antenna is coupled to said electronics and said electronics includes circuitry for detecting a signal received by the antenna;
wherein at least some of the power for operating the hearing aid is derived from said signal.

2. The hearing aid as set forth in claim 1 wherein said circuitry for detecting a signal includes a capacitor for storing energy as a voltage on the capacitor.

3. The hearing aid as set forth in claim 2 wherein said hearing aid is characterized by not having a battery and all the power for operating the hearing aid is derived from said signal.

4. The hearing aid as set forth in claim 1 wherein said hearing aid includes a battery and at least some of the power for operating the hearing aid is derived from the battery.

5. The hearing aid as set forth in claim 4 wherein said electronics includes circuitry for charging the battery from said signal.

6. The hearing aid as set forth in claim 1 wherein said electronics includes circuitry for demodulating said signal.

7. The hearing aid as set forth in claim 6 wherein said electronics includes a transmitter coupled to said antenna.

8. A hearing aid system comprising:
a hearing aid including electronic circuitry for processing radio frequency (RF) and audio signals, an antenna coupled to said electronic circuitry, wherein said electronic circuitry includes an RF detector;
a first transmitter for producing an RF signal;
wherein at least some of the power for operating the hearing aid is derived from said RF signal by the RF detector.

9. The hearing aid system as set forth in claim 8 wherein said RF detector includes a capacitor for storing energy as a voltage on the capacitor.

10. The hearing aid system as set forth in claim 9 wherein said hearing aid is characterized by not having a battery and all the power for operating the hearing aid system is derived from said signal.

11. The hearing aid system as set forth in claim 8 wherein said hearing aid includes a battery and at least some of the power for operating the hearing aid is derived from the battery.

12. The hearing aid system as set forth in claim 11 wherein said electronic circuitry includes a charger for charging the battery from said signal.

13. The hearing aid system as set forth in claim 8 wherein said first transmitter is portable.

14. The hearing aid system as set forth in claim 8 wherein said first transmitter produces a modulated carrier.

15. The hearing aid system as set forth in claim 14 wherein said electronic circuitry includes a demodulator.

16. The hearing aid system as set forth in claim 15 wherein said modulated carrier provides power and at least one of data and control for said hearing aid.

17. The hearing aid system as set forth in claim 8 wherein said electronic circuitry includes a second transmitter coupled to said antenna.
